(19) United States
(12) Patent Application Publication
(10) Pub. No.: US 2026/0062527 A1
(43) Pub. Date: Mar. 5, 2026

(54) Stretchable Oxygen Barrier Coatings

(71) Applicant: Henkel AG & Co. KGaA, Düsseldorf (DE)

(72) Inventors: Matthew Ahearn, Union, NJ (US); Guido Kollbach, Bridgewater, NJ (US)

(21) Appl. No.: 19/385,257

(22) Filed: Nov. 11, 2025

Related U.S. Application Data
(63) Continuation of application No. PCT/US2024/029363, filed on May 15, 2024.
(60) Provisional application No. 63/502,188, filed on May 15, 2023.

(51) Int. Cl. C08J 7/048; C08J 5/18; C09D 7/63; C09D 129/04

(52) U.S. Cl. CPC C08J 7/048; C08J 5/18; C09D 7/63; C09D 129/04; C08J 2323/12

(57) ABSTRACT

Provided herein are materials for forming an oxygen barrier coating for a stretchable flexible film that exhibits high stretchability and excellent oxygen barrier properties. The present materials are compatible with biaxial stretching (e.g., to ten times the original area), and retain clarity and oxygen barrier functionality following stretch. Also disclosed are coated films that include the inventive oxygen barrier coatings, as well as packaging materials and articles comprising the coated films.

### TECHNICAL FIELD

The present disclosure pertains to coatings for stretchable films.

### BACKGROUND

Flexible film packaging material is widely used due to its versatility and ability to accommodate unique specifications and market objectives. Flexible film may be customized based on the particular shape, size, or visual needs of the product being packaged. The films can serve to protect and secure products for retail and shipping environments, and can also be customized with respect to visual properties, including clarity, glossiness, and printability. The benefits of such materials include durability and resistance to tearing, safe distribution and storage, freshness and food safety, and protection from environmental elements like temperature, light, moisture, and gas. Flexible film helps to increase the shelf life of perishable items and can conceal the smells of the packaging's contents. Materials such a polyvinyl chloride, polyolefin, and polyethylene are in widespread use for flexible film production.

Biaxial orientation is a process whereby a plastic film or sheet is stretched in such a way that the polymeric chains are oriented parallel to the plane of the film. Biaxially oriented films exhibit exceptional clarity, very high tensile properties, improved flexibility and toughness, improved barrier properties, and can be relatively easily made shrinkable.

Improvements in the properties of packaging materials that are formed using films would have far ranging benefits for film producers, suppliers, and users.

### SUMMARY

Disclosed herein are materials for forming an oxygen barrier coating for a film comprising a polymer or a mixture of polymers having a crystallization temperature change (ΔTc) of at least 40° C. as measured according to D3418-12, a Brookfield viscosity of about 1-75 cP at 25° C., spindle #2 at 100 RPM, wherein the material, when coated onto a stretchable polymeric flexible film having an unstretched area, can be stretched with the stretchable polymeric flexible film to an stretched area that is at least two times the unstretched area.

Also provided herein are coated films comprising a polymeric flexible film material having a first face and an opposed second face, and a material as described in the preceding paragraph coated onto the first face of the polymeric flexible film. The present disclosure also pertains to packaging materials comprising a coated film as provided herein, and to articles comprising such packaging materials.

The present disclosure also provides methods for forming a packaging material with oxygen barrier properties comprising applying a material as disclosed herein onto at least a portion of a first face of a polymeric flexible film.

### BRIEF DESCRIPTION OF THE DRAWINGS

FIG. 1 provides a DSC evaluation of a material according to the present disclosure, as compared with other polymer resins.

FIG. 2 depicts a DSC evaluation with respect to a material according to the present disclosure in isolation.

### DETAILED DESCRIPTION OF ILLUSTRATIVE EMBODIMENTS

The presently disclosed inventive subject matter may be understood more readily by reference to the following detailed description taken in connection with the accompanying figures and examples, which form a part of this disclosure. It is to be understood that these inventions are not limited to the specific components, methods, or parameters described and/or shown herein, and that the terminology used herein is for the purpose of describing particular embodiments by way of example only and is not intended to be limiting of the claimed inventions.

The entire disclosures of each patent, patent application, and publication cited or described in this document are hereby incorporated herein by reference.

As employed above and throughout the disclosure, the following terms and abbreviations, unless otherwise indicated, shall be understood to have the following meanings.

In the present disclosure the singular forms “a,” “an,” and “the” include the plural reference, and reference to a particular numerical value includes at least that particular value, unless the context clearly indicates otherwise. Thus, for example, a reference to “a layer” is a reference to one or more of such layers and equivalents thereof known to those skilled in the art, and so forth. Furthermore, when indicating that a certain element “may be” X, Y, or Z, it is not intended by such usage to exclude in all instances other choices for the element.

When values are expressed as approximations, by use of the antecedent “about,” it will be understood that the particular value forms another embodiment. In general, use of the term “about” indicates approximations that can vary depending on the desired properties sought to be obtained by the disclosed subject matter and is to be interpreted in the specific context in which it is used, based on its function. In some embodiments, “about X” (where X is a numerical value) refers to ±10% of the recited value, inclusive. For example, the phrase “about 8” can refer to a value of 7.2 to 8.8, inclusive. This value may include “exactly 8”. When the term “about” precedes a list of optional numerical values, the phrase can be construed such that the term “about” modifies each of the members of the list, e.g., “about 1, 2, 3, or 4” can be construed as “about 1, about 2, about 3, or about 4”. Likewise “about 1-4” can be construed as “about 1, about 2, about 3, or about 4”.

Where present, all ranges are inclusive and combinable. For example, when a range of “1 to 5” is recited, the recited range should be construed as optionally including ranges “1 to 4”, “1 to 3”, “1-2”, “1-2 & 4-5”, “1-3 & 5”, and the like. In addition, when a list of alternatives is positively provided, such a listing can also include embodiments where any of the alternatives may be excluded. For example, when a range of “1 to 5” is described, such a description can support situations whereby any of 1, 2, 3, 4, or 5 are excluded; thus, a recitation of “1 to 5” may support “1 and 3-5, but not 2”, or simply “wherein 2 is not included.”

As described above, flexible film packaging materials are in widespread use, and improvements in the properties thereof could confer immediate benefits with respect to the presentation, conveyance, storage, display, and safety of a variety of commercial products. The present inventors have surprisingly discovered materials for forming an oxygen barrier coating for a stretchable flexible film that exhibits high stretchability and excellent oxygen barrier properties. The present materials are compatible with stretching flexible films (e.g., to ten times the original area or greater), and retain clarity and oxygen barrier functionality following stretch.

Accordingly, in one embodiment, disclosed herein are materials for forming an oxygen barrier coating for a film comprising a polymer or a mixture of polymers having a crystallization temperature change (ΔTc) of at least 40° C. as measured according to D3418-12, a Brookfield viscosity of about 1-75 cP at 25° C., spindle #2 at 100 RPM, wherein the material, when coated onto a stretchable polymeric flexible film having an unstretched area, can be uniaxially or biaxially stretched with the stretchable polymeric film to an stretched area that is at least two, three, four, five, six, seven, eight, nine, ten, eleven, twelve, fifteen, twenty, thirty, forty, fifty, sixty, seventy, eighty, ninety or hundred times the unstretched area.

In some embodiments, the material comprises a single polymer, and in other embodiments, the material comprises a mixture of two or more polymers. For example, the material may comprise a mixture of two, three, four, five, or more individual polymer species. When combined, the chosen polymer species, and the relative proportions of the individual polymer species yield a material that is characterized by a crystallization temperature change (ΔTc) of at least 40° C. and a Brookfield viscosity of about 1-75 cP at 25° C. The present inventors have found that these and other characteristics provide an optimal balance of crystallinity, viscosity, and stretchability in order to confer compatibility with biaxial stretching to several times the unstretched area of material.

In some embodiments, the material comprises a mixture of (i) a first butenediol vinyl alcohol copolymer and (ii) a second butenediol vinyl alcohol copolymer.

The first butenediol vinyl alcohol copolymer may have a viscosity of about 2-5 mPa's when measured in a 4% aqueous solution at 20° C. For example, the first butenediol vinyl alcohol copolymer may have a viscosity of about 2.25-4.5, 2.5-4, 2.5-3.75, 2.5-3.5, or about 2, 2.25, 2.5, 2.75, 3, 3.25, 3.5, 3.75, 4, 4.25, 4.5, 4.75, or 5 mPa·s when measured in a 4% aqueous solution at 20° C. The first butenediol vinyl alcohol copolymer may have a melting point of about 170-174° C. as measured by DSC according to ASTM D3418-12. For example, the first butenediol vinyl alcohol copolymer may have a melting point of about 170, 170.5, 171, 171.5, 172, 172.5, 173, 173.5, or 174° C. as measured by DSC according to ASTM D3418-12.

The second butenediol vinyl alcohol copolymer may have a viscosity of about 2.5-5.5 mPa's when measured in a 4% aqueous solution at 20° C. For example, the second butenediol vinyl alcohol copolymer may have a viscosity of about 2.5-5.25, 2.75-5.25, 3-5.25, 3-5, or about 2.5, 2.75, 3, 3.25, 3.5, 3.75, 4, 4.25, 4.5, 4.75, 5, 5.25, or 5.5 mPa·s when measured in a 4% aqueous solution at 20° C. The second butenediol vinyl alcohol copolymer may have a melting point of about 157-161° C. as measured by DSC according to ASTM D3418-12. For example, the first butenediol vinyl alcohol copolymer may have a melting point of about 157, 157.5, 158, 158.5, 159, 159.5, 160, 160.5, or 161° C. as measured by DSC according to ASTM D3418-12.

In certain embodiments comprising a first butenediol vinyl alcohol copolymer and a second butenediol vinyl alcohol copolymer, the second butenediol vinyl alcohol copolymer has a viscosity of when measured in a 4% aqueous solution at 20° C. that is higher than a viscosity of the first butenediol vinyl alcohol copolymer when measured in a 4% aqueous solution at 20° C. In some embodiments comprising a first butenediol vinyl alcohol copolymer and a second butenediol vinyl alcohol copolymer, the second butenediol vinyl alcohol copolymer has a lower melting point than the first butenediol vinyl alcohol copolymer, as measured by DSC according to ASTM D3418-12.

In some embodiments comprising a first butenediol vinyl alcohol copolymer and a second butenediol vinyl alcohol copolymer, the first butenediol vinyl alcohol copolymer and the second butenediol vinyl alcohol copolymer are present in the coating in a ratio of about 2.3-4:1. For example, the first butenediol vinyl alcohol copolymer and the second butenediol vinyl alcohol copolymer may be present in the coating in a ratio of about 2.5-3.5:1, 2.75-3.75:1, or 3:1.

The present materials for forming an oxygen barrier coating for a film may have a Brookfield viscosity of about 35-70 cP at 25° C., spindle #2 at 100 RPM. For example, the materials may have a Brookfield viscosity of about 35, 36, 37, 38, 39, 40, 41, 42, 43, 44, 45, 46, 47, 48 49, 50, 51, 52, 53, 54, 55, 56, 57, 58, 59, 60, 61, 62, 63, 64, 65, 66, 67, 68, 69, 70, or 40-70, 45-65, 50-60, or 52-57 cP at 25° C., spindle #2 at 100 RPM.

The solids content of the material may be about 10-20%. For example, the solids content may be about 10, 11, 12, 13, 14, 15, 16, 17, 18, 19, 20, or 12-20, 12-18, 14-17, or 15-16%.

The present materials have a crystallization temperature change (ΔTc) of at least 40° C. as measured according to D3418-12. In some embodiments, the materials have a ΔTc of about or at least 50, 51, 52, 53, 54, 55, 56, 57, 58, 59, 60, 61, 62, 63, 64, 65, 66, 67, 68, 69, 70° C., or about 50-70, 55-70, 60-70, or 65-70° C. as measured according to D3418-12.

The present materials may be characterized by an onset of crystallization that occurs at a temperature of about 130-155° C. as measured by DSC according to ASTM D3418-12. For example, the materials have an onset of crystallization of about 130, 131, 132, 133, 134, 135, 136, 137, 138, 139, 140, 141, 142, 143, 144, 145, 146, 147, 148, 149, 150, 151, 152, 153, 154, or 155° C. as measured by DSC according to ASTM D3418-12.

The present materials may also or alternatively be characterized by an enthalpy AH of about 16-18 J/g, such as about 16, 17, or 18 J/g.

The present materials may further include additives to improve wet-out performance onto polymeric films. The additives include solvents and surfactants. Non-limiting list of solvents include esters such as ethyl acetate, n-propyl acetate, isopropyl acetate, and neopentyl acetate; ketones such as acetone; alcohols such as ethanol, n-propanol and isopropanol; and mixtures thereof. Non-limiting list of surfactants include polysiloxanes, organomodified siloxanes, polyether-modified siloxanes, ethoxylated alcohols, alcohol alkoxylates, fatty acid esters, polyalkylene glycol, polyethylene glycol, and modified succinic acid and esters, and mixtures thereof. The additives may be included up to 5 wt %, 4 wt %, 3 wt %, 2 wt %, or 1 wt %, based on the total weight of the present materials.

The present materials, when coated onto a stretchable polymeric film having an unstretched area, can be uniaxially or biaxially stretched with the stretchable polymeric film to a stretched area that is greater than the initial unstretched area. In some embodiments, the stretched area of the material and stretchable polymeric flexible film is at least or about 2, 3, 4, 5 6, 7, 8, 9, or 10 times greater than the initial unstretched area of the material and stretchable polymeric film. The inventive materials retain their integrity, clarity, and oxygen barrier functionality when stretched with the polymeric film onto which the materials are coated, which represents an advantage over existing coatings that may be either stretchable to the desired degree or provide desirable oxygen barrier functionality, but not both, or that do not have the aesthetic characteristics or compatibility with packaging design features following stretching.

In some embodiments, the present materials for forming an oxygen barrier coating for a film comprising a polymer or a mixture of polymers having a crystallization temperature change (ΔTc) of about 55-70° C. as measured according to D3418-12, a Brookfield viscosity of about 45-65 cP at 25° C., spindle #2 at 100 RPM, and an onset of crystallization that occurs at a temperature of about 145-160° C., as measured by DSC according to ASTM D3418-12, wherein the material, when coated onto a stretchable polymeric flexible film having an initial unstretched area, can be uniaxially or biaxially stretched with the stretchable polymeric flexible film to an stretched area that is at least two times the initial unstretched area.

In certain embodiments, the present materials for forming an oxygen barrier coating for a film comprising a polymer or a mixture of polymers having a crystallization temperature change (ΔTc) of about 60-70° C. as measured according to D3418-12, a Brookfield viscosity of about 52-60 cP at 25° C., spindle #2 at 100 RPM, and an onset of crystallization that occurs at a temperature of about 147-155° C., as measured by DSC according to ASTM D3418-12, wherein the material, when coated onto a stretchable polymeric flexible film having an initial unstretched area, can be uniaxially or biaxially stretched with the stretchable polymeric film to an stretched area that is at least two times the unstretched area.

Also disclosed herein are coated films comprising a polymeric flexible film material having a first face and an opposed second face, and, coated onto the first face of the polymeric flexible film, a material according to any of the embodiments described above.

The polymeric flexible film preferably comprises any polymeric species or combination of polymeric species that may be used for forming wrapping or packaging films, including stretchable films, e.g., biaxially stretchable films. In some embodiments, the polymeric flexible film comprises an olefin. For example, the polymeric flexible film may comprise polypropylene (PP), polyethylene (PE), low density polyethylene (LDPE), linear low density polyethylene (LLDPE), or any combination thereof. The polymeric flexible film may also or alternatively comprise polyamide (PA), poly lactic acid (PLA), polyphenylsulfone (PPSU), polyphenylene sulfide (PPS), polyvinyl chloride (PVC), polyimide kapton (PI), polyethylene terephthalate (PET), polybutylene terephthalate (PBT), polyethylene naphthalate (PEN), MDO-PE (machine direction oriented PE), biaxially oriented polyethylene (BOPE), biaxially oriented polypropylene (BOPP), cast polypropylene (CPP), oriented polyamide (OPA), or any combination thereof. As noted, the polymeric flexible film may be suitable for biaxial stretching.

Flexible films may be stretched uniaxially (single direction) off-line or in-line with Machine Direction Orienter (MDO). The MDO induces orientation in the polymer structure of the flexible film or sheet in the machine direction by, the films are stretch in parallel/machine direction, or in the direction of the machine by stretching it longitudinally at an elevated temperature. This results in down-gauging a film's thickness while retaining or improving its physical properties. The process may also be used to modify performance characteristics such as tensile strength, modulus, elongation, clarity, haze, shrinkage, oxygen barrier, water vapor barrier, porosity, and the like. Film thickness from uniaxially stretching can vary depending on the polymer film or sheet, and the desired effects.

Machine direction orientation (MDO) stretching machines are typically used to cast, blow, and stretch film uniaxially (monoaxially) on-line or off-line. In one embodiment, the material for forming an oxygen barrier coating is applied to the film before it is stretched uniaxially. In another embodiment, the coating is applied to the film after it is stretched uniaxially. The coating weight of the material on the polymeric flexible film ranges from about 0.1 to about 50 gsm. For example, the coating weight of the material may be about 0.1, 0.2, 0.3, 0.4, 0.5, 0.6, 0.7, 0.8, 0.9 1, 2, 3, 4, 5, 6, 7, 8, 9, 10, 15, 20, 25, 30, 35, 40, 45, or 50 gsm. The thickness of the polymeric film may be, for example, about 10 to 150 μm. For example, the thickness of the film may be about 10-100, 10-50, 10-25, or 12-25 μm.

The present methods may further comprise stretching transversal direction, whereby the film results in biaxially stretched. The transversal stretching is perpendicular to the machine direction (MD) stretching. Such transversal stretching of the coated flexible film may be performed using equipment and techniques that are known among those skilled in the art. See, e.g., U.S. Pat. No. 11,453,025, incorporated herein by reference. The Brückner KARO® 5.0 system represents exemplary equipment for biaxial stretching of a polymeric flexible film. Transverse Direction Orienter (TDO) machines provides biaxially stretched coated film by continuous, in-line stretching, where the flexible film is stretched in single direction, coated with the materials for forming an oxygen barrier coating, and then stretched in transversal direction also referred to as biaxial stretching. In another embodiment, biaxially oriented film stretching machine (BIAX) can stretch a flexible film, with pre-applied coating, in both directions, machine direction and transverse direction, simultaneously.

When stretched, the coated films according to the present disclosure may have an oxygen transmission rate of about less than 20, preferably from 3-15 cc/m² per day at 0% relative humidity. For example, the coated films may have an oxygen transmission rate of about 3, 4, 5, 6, 7, 8, 9, 10, 11, 12, 13, 14 or 15 cc/m² per day at 0% relative humidity.

Also disclosed herein are packaging materials comprising a coated, stretched film according to any of the preceding embodiments. The packaging materials comprise a coated film that has been stretched from an original area to a stretched area. In another embodiment, the packaging materials may comprise a stretch film that has been stretched uniaxially, coated with the material for forming an oxygen barrier coating, and then further stretched in a transversal direction than the previous MD direction. The resultant stretched, coated film may have been stretched in a transverse direction, that is at least or about ten times the area of the coated film prior to biaxially stretching. For example, the stretched film may have been stretched to area that is at least or about 10, 20, or 100 times the area prior to stretching. The stretched area is calculated as the stretched sides of both x and y directions.

Following a step of stretching, the present methods may additionally comprise adhering a second flexible film layer having first and second opposing faces to the polymeric flexible film such that the first face of the second flexible film layer is adhered to at least a portion of the coated first face of the polymeric flexible film.

The second film layer may comprise, for example, any polymeric species or combination of polymeric species that may be used for forming wrapping or packaging films, including stretchable films, e.g., biaxially stretchable films. In some embodiments, the second film layer comprises an olefin. For example, the second film layer may comprise polypropylene (PP), polyethylene (PE), low density polyethylene (LDPE), linear low density polyethylene (LLDPE), or any combination thereof. The polymeric film may also or alternatively comprise polyamide (PA), poly lactic acid (PLA), polyphenylsulfone (PPSU), polyphenylene sulfide (PPS), polyvinyl chloride (PVC), polyimide kapton (PI), polyethylene terephthalate (PET), or any combination thereof. The second flexible film may optionally be metallized.

The polymeric flexible film may be cooled following stretching and prior to adhering the second flexible layer to the polymeric flexible film.

In order to adhere the polymeric flexible film to the second flexible film layer, the polymeric flexible film, the second flexible film layer, or both may be coated with a laminating adhesive. Exemplary laminating adhesives can readily be identified by those skilled in the art, and may include, for example, polyurethanes, which may be solvent-based, solvent-free, or water-based. Solvent-based and solvent-free polyurethane adhesives are preferred. Polyurethane adhesives are based on reaction of an isocyanate moiety containing component with an isocyanate reactive component. In another embodiment, the laminating adhesive may be coated onto the oxygen-barrier coating and undergo a crosslinking reaction to provide a better adhesion.

Also provided herein are methods for forming a packaging material with oxygen barrier properties comprising applying an inventive oxygen barrier coating material according to any of the embodiments of the present disclosure onto at least a portion of a first face of a polymeric flexible film. The polymeric flexible film may be in accordance with any of the embodiments disclosed above in connection with the inventive coated, stretched films. The application of the oxygen barrier coating material onto the polymeric flexible film, such as the volume per square unit of coating that is applied, the final thickness of the coating, the technique for spreading the material onto the face of the polymeric flexible film, and the like, may be in accordance with conventional film coating techniques. The oxygen barrier coating material can be applied onto the polymeric flexible film substrate using any suitable printing method such as offset printing, direct or reverse gravure printing, or silk screen printing, or using a suitable coating method such as roll coating, knife edge coating, direct or reverse gravure coating, or flexographic coating. After coating, the applied mixed solution is heated to about 50 to 200° C., for example, and dried and/or cured, such as is described in U.S. Pat. No. 10,336,044.

The present methods may further include a step of metallizing the coated first face of the polymeric flexible film. In some embodiments, the methods may also or alternatively include metallizing the second face of the second flexible film layer after the first face of the second flexible film layer is adhered to the polymeric flexible film. Metallizing species for polymeric flexible films include, for example, aluminum, AlOx, and SiOx.

The packaging materials according to the present disclosure may further comprise a second flexible film layer that is positioned on at least a portion of the first face of the coated film, i.e., on top of the coating of the inventive oxygen barrier material that is present on the first face of the film. The second flexible film layer may comprise, for example, a polymeric film, a metallic film, or paper. Exemplary polymeric films that may be used for the second flexible film include polypropylene (PP), polyethylene (PE), low density polyethylene (LDPE), linear low density polyethylene (LLDPE), or any combination thereof. The polymeric flexible film may also or alternatively comprise polyamide (PA), poly lactic acid (PLA), polyphenylsulfone (PPSU), polyphenylene sulfide (PPS), polyvinyl chloride (PVC), polyimide kapton (PI), polyethylene terephthalate (PET), polybutylene terephthalate (PBT), polyethylene naphthalate (PEN), MDO-PE (machine direction oriented PE), biaxially oriented polyethylene (BOPE), biaxially oriented polypropylene (BOPP), cast polypropylene (CPP), oriented polyamide (OPA), or any combination thereof. Exemplary metallic film materials include aluminum, AlOx, SiOx, or a combination thereof. In some embodiments, the second flexible film layer may be a laminate, i.e., may itself comprise two or more layers. The packaging materials may optionally include one or more layers that are interposed between the coated, stretched film and the second flexible film. Such intermediate layers may include a moisture barrier layer, a varnish layer, or an inorganic oxide layer. When the second flexible film layer is a laminate, a first laminate-forming layer may be a polymeric film, a metallic film, or paper, and a second laminate-forming layer may be a polymeric film, a metallic film, or paper. In such instances, the first laminate-forming layer may be the same as or different from the second laminate-forming layer. For example, the first laminate-forming layer may be one of a polymeric film, a metallic film, or paper, and the second laminate-forming layer may be the same or a different one of a polymeric film, a metallic film, or paper. Alternatively, the first laminate-forming layer may be one of a polymeric film, a metallic film, or paper, and the second laminate-forming layer may be the same type of layer, but a different species. For example, the first laminate-forming layer may be a first species of a polymeric film, and the second laminate-forming layer may be a different species of a polymeric film that is different from the first species of a polymeric film. The addition of the metallized layer further decreases oxygen transmission and improves barrier properties of the package.

The present disclosure also provides articles comprising a packaging material according to any one of the embodiments disclosed herein. The article may be, for example, a bag, pouch, sleeve, carton, cannister, box, tray, bowl, cup, or any other container for housing a consumer product prior to use. The packaging material may form all, substantially all, or a portion of the article. For example, if the article is a pouch (such as for containing a snack food item), the packaging material may form the majority or all of the pouch. In an embodiment in which the article is a resilient vessel such as a tray, bowl, or cup, the packaging material may include lidding film that is used to cover the vessel and retain the contents within the vessel prior to use. The lidding film may comprise the packaging material, and the vessel itself may or may not comprise packaging material according to an embodiment disclosed herein.

Also provided herein are methods for forming a packaging article comprising shaping a coated flexible film according to any one or more of the embodiments disclosed herein into a container. Shaping may include any technique for forming a container that is capable of housing a material, such a food item. The shaping may form a container or a portion thereof. For example, the shaping may include binding together certain edges of the coated, stretched film in order to form a bag or pouch. In other embodiments, wherein the coated, stretched film forms a portion of a container, the shaping may include wrapping the coated, stretched film around a framework, extending the coated, stretched film between two or more other container components, or placing the coated, stretched film over the opening over another container component in order to provide a box, cannister, or sealed vessel. The container therefore be, for example, a bag, pouch, sleeve, carton, cannister, box, tray, bowl, cup, or any other container, for example, for housing a consumer product prior to use.

The present disclosure also pertains to and includes at least the following aspects:
Aspect 1. A material for forming an oxygen barrier coating for a flexible film comprising a polymer or a mixture of polymers having a crystallization temperature change (ΔTc) of at least 40° C. as measured according to D3418-12, a Brookfield viscosity of about 1-75 cP at 25° C., spindle #2 at 100 RPM, wherein the material, when coated onto a stretchable polymeric flexible film having an initial unstretched area, can be uniaxially or biaxially stretched with the stretchable polymeric flexible film to an stretched area that is at least two times the initial unstretched area.
Aspect 2. The material according to aspect 1, comprising a mixture of (i) a first butenediol vinyl alcohol copolymer and (ii) a second butenediol vinyl alcohol copolymer.
Aspect 3. The material according to aspect 2, wherein the first butenediol vinyl alcohol copolymer has a viscosity of about 2-5 mPa·s when measured in a 4% aqueous solution at 20° C.
Aspect 4. The material according to aspect 2 or aspect 3, wherein the first butenediol vinyl alcohol copolymer has a viscosity of about 2.5-3.5 mPa·s when measured in a 4% aqueous solution at 20° C.
Aspect 5. The material according to any one of aspects 2-4, wherein the second butenediol vinyl alcohol copolymer has a viscosity of about 2.5-5.5 mPa·s when measured in a 4% aqueous solution at 20° C.
Aspect 6. The material according to any one of aspects 2-5, wherein the second butenediol vinyl alcohol copolymer has a viscosity of about 3-5 mPa·s when measured in a 4% aqueous solution at 20° C.
Aspect 7. The material according to any one of aspects 2-6, wherein the second butenediol vinyl alcohol copolymer has a viscosity of when measured in a 4% aqueous solution at 20° C. that is higher than a viscosity of the Polymer 1 when measured in a 4% aqueous solution at 20° C.
Aspect 8. The material according to any one of aspects 2-7, wherein the first butenediol vinyl alcohol copolymer has a melting point of about 170-174° C. as measured by DSC according to ASTM D3418-12.
Aspect 9. The material according to any one of aspects 2-8, wherein the first butenediol vinyl alcohol copolymer has a melting point of about 172° C. as measured by DSC according to ASTM D3418-12.
Aspect 10. The material according to any one of aspects 2-9, wherein the second butenediol vinyl alcohol copolymer has a melting point of about 157-161° C. as measured by DSC according to ASTM D3418-12.
Aspect 11. The material according to any one of aspects 2-10, wherein the first butenediol vinyl alcohol copolymer has a melting point of about 159° C. as measured by DSC according to ASTM D3418-12.
Aspect 12. The material according to any one of aspects 2-11, wherein the first butenediol vinyl alcohol copolymer and the second butenediol vinyl alcohol copolymer are present in the coating in a ratio of about 2.3-4:1
Aspect 13. The material according to any one of aspects 2-12, wherein the first butenediol vinyl alcohol copolymer and the second butenediol vinyl alcohol copolymer are present in the coating in a ratio of about 2.5-3.5:1.
Aspect 14. The material according to any one of aspects 2-13, wherein the first butenediol vinyl alcohol copolymer and the second butenediol vinyl alcohol copolymer are present in the coating in a ratio of about 2.75-3.75:1.
Aspect 15. The material according to any one of aspects 2-14, wherein the first butenediol vinyl alcohol copolymer and the second butenediol vinyl alcohol copolymer are present in the coating in a ratio of about 3:1.
Aspect 16. The material according to any preceding aspect, wherein the coating has a Brookfield viscosity of about 35-70 cP at 25° C., spindle #2 at 100 RPM.
Aspect 17. The material according to any preceding aspect, wherein the coating has a Brookfield viscosity of about 45-65 cP at 25° C., spindle #2 at 100 RPM.
Aspect 18. The material according to any preceding aspect, wherein the coating has a Brookfield viscosity of about 55 cP at 25° C., spindle #2 at 100 RPM.
Aspect 19. The material according to any preceding aspect having a solids content of about 10-20%.
Aspect 20. The material according to any preceding aspect having a solids content of about 12-18%.
Aspect 21. The material according to any preceding aspect having a solids content of about 15%.
Aspect 22. The material according to any preceding aspect having a ΔTc of at least 50° C.
Aspect 23. The material according to any preceding aspect having a ΔTc of at least 55° C.
Aspect 24. The material according to any preceding aspect having ΔTc of at least 60° C.
Aspect 25. The material according to any preceding aspect having a ΔTc of at least 65° C.
Aspect 26. A coated film comprising: a polymeric film material having a first face and an opposed second face, and a material according to any one of aspects 1-25 coated onto the first face of the polymeric film.
Aspect 27. The coated film according to aspect 26, wherein the polymeric flexible film material comprises an olefin.
Aspect 28. The coated film according to aspect 26, wherein the polymeric flexible film material comprises polypropylene (PP), polyethylene (PE), low density polyethylene (LDPE), linear low density polyethylene (LLDPE), or any combination thereof.
Aspect 29. The coated film according to aspect 26, wherein the polymeric flexible film material comprises polyamide (PA), poly lactic (PLAs), polyphenylsulfone (PPSU), polyphenylene sulfide (PPS), polyvinyl chloride (PVC), polyimide kapton (PI), polyethylene terephthalate (PET), polypropylene (PP), polyethylene (PE), polyhydroxyalkanoates (PHA) such as polyhydroxybutyrate (PHB), polyhydroxyhexanoate (PHH), polyhydroxyvalorate (PHV), polyhydroxybutyrate-co-valerate (PHBV), or any combination thereof
Aspect 30. The coated film according to any one of aspects 26-29, wherein polymeric flexible film material is suitable for biaxial stretching.
Aspect 31. The coated film according to any one of aspects 26-30, wherein the coated film when dried and stretched has an oxygen transmission rate of about 3-15 cc/m² per day at 0% relative humidity.
Aspect 32. The coated film according to any one of aspects 26-31, wherein the coated film when dried and stretched has an oxygen transmission rate of about 3-10 cc/m² per day at 0% relative humidity.
Aspect 33. The coated film according to any one of aspects 26-32, wherein the coated film when dried and stretched has an oxygen transmission rate of about 3-5 cc/m² per day at 0% relative humidity.
Aspect 34. A packaging material comprising a coated film according to any one of aspects 26-33.
Aspect 35. The packaging material according to aspect 34, wherein the coated film has been uniaxially or biaxially stretched.
Aspect 36. The packaging material according to aspect 35, wherein the coated film when dried and stretched has an oxygen transmission rate of about 3-15 cc/m² per day at 0% relative humidity.
Aspect 37. The packaging material according to aspect 35, wherein the coated film when dried and stretched has an oxygen transmission rate of about 3-10 cc/m² per day at 0% relative humidity.
Aspect 38. The packaging material according to aspect 35, wherein the coated film when dried and stretched has an oxygen transmission rate of about 3-5 cc/m² per day at 0% relative humidity.
Aspect 39. The packaging material according to aspect 34, further comprising a second flexible film layer that is positioned on at least a portion of the first face of the coated film.
Aspect 40. The packaging material according to aspect 39, wherein the second flexible film layer is bound to at least a portion of the first face the coated film via an adhesive.
Aspect 41. The packaging material according to aspect 30 or aspect 40, wherein the second flexible film layer comprises polymeric film, a metallic film, or paper.
Aspect 42. An article comprising a packaging material according to any one of aspects 34-41.
Aspect 43. The article according to aspect 42 comprising a bag, pouch, sleeve, carton, cannister, box, tray, bowl, or cup.
Aspect 44. A method for forming a packaging material with oxygen barrier properties comprising applying a material according to any one of aspects 1-25 onto at least a portion of a first face of a polymeric film.
Aspect 45. The method according to aspect 44, further comprising biaxially stretching the coated polymeric film.
Aspect 46. The method according to aspect 44 or aspect 45, further comprising adhering a second flexible film layer having first and second opposing faces to the polymeric film such that the first face of the second flexible film layer is adhered to at least a portion of the coated first face of the polymeric film.
Aspect 47. The method according to aspect 44, further comprising metallizing the coated first face of the polymeric film.
Aspect 48. The method according to aspect 46 or aspect 47, further comprising metallizing the second face of the second flexible film.
Aspect 49. A method for forming a packaging article comprising shaping a coated film according to any one of aspects 26-33 into a container.

### EXAMPLES

The present invention is further defined in the following Examples. It should be understood that these examples, while indicating preferred embodiments of the invention, are given by way of illustration only, and should not be construed as limiting the appended claims From the above discussion and these examples, one skilled in the art can ascertain the essential characteristics of this invention, and without departing from the spirit and scope thereof, can make various changes and modifications of the invention to adapt it to various usages and conditions.

### Example 1—Preparation of Material for Forming an Oxygen Barrier Coating for a Film

Oxygen barrier coating material was prepared using the components provided below in Table 1, in the specified amounts:

TABLE 1

| Component | Amount (g) | wt % |
|---|---|---|
| Deionized water | 849.00 | 84.90 |
| Polymer 1 | 112.50 | 11.25 |
| Benzisothiazolinone | 1.00 | 0.10 |
| Polymer 2 | 37.50 | 3.75 |
| Total | 1000.00 | 100.00 |

Polymer 1 is a butenediol vinyl alcohol copolymers having a viscosity of 3.0 mPas and melting point of about 172° C. Polymer 2 is a butenediol vinyl alcohol copolymers having a viscosity of 4.5 mPas and melting point of about 159° C. Water was charged to the reactor, followed by slow addition of the polymers with mixing @ 25° C. It was confirmed that the condenser was running, and heating to 85° C. was commenced. The batch was held at this temperature for two hours, after which time it was cooled to 25° C. Then, the biocide (benzisothiazolinone) was charged to the reactor, and mixing was performed for 30 minutes. The mixed material was filtered through a coarse filter and discharged into pails. A small sample was retained for quality control purposes. Characteristics of the final product was as follows: visually clear; 14.5-15.5% solids; 45-65 cps @ 25° C. Brookfield viscosity; and, 16-18 seconds @ 25° C. Zahn #2 cup viscosity.

### Example 2—DSC Evaluation of Oxygen Barrier Coating Material

Differential scanning calorimetry (DSC) evaluation of the oxygen barrier coating material prepared in accordance with Example 1 as well as of the underlying base resins, Polymer 1 and Polymer 2. The DSC instrument was model number DSC2A-02012 (TA Instruments, New Castle, DE), and the DSC method was in accordance with ASTM D3418-12: (1) equilibrate at −82° C.; (2) heat at 10° C./min from −82° C. to 220° C.; and, (3) cool at 10° C./min from 220° C. to −82° C.

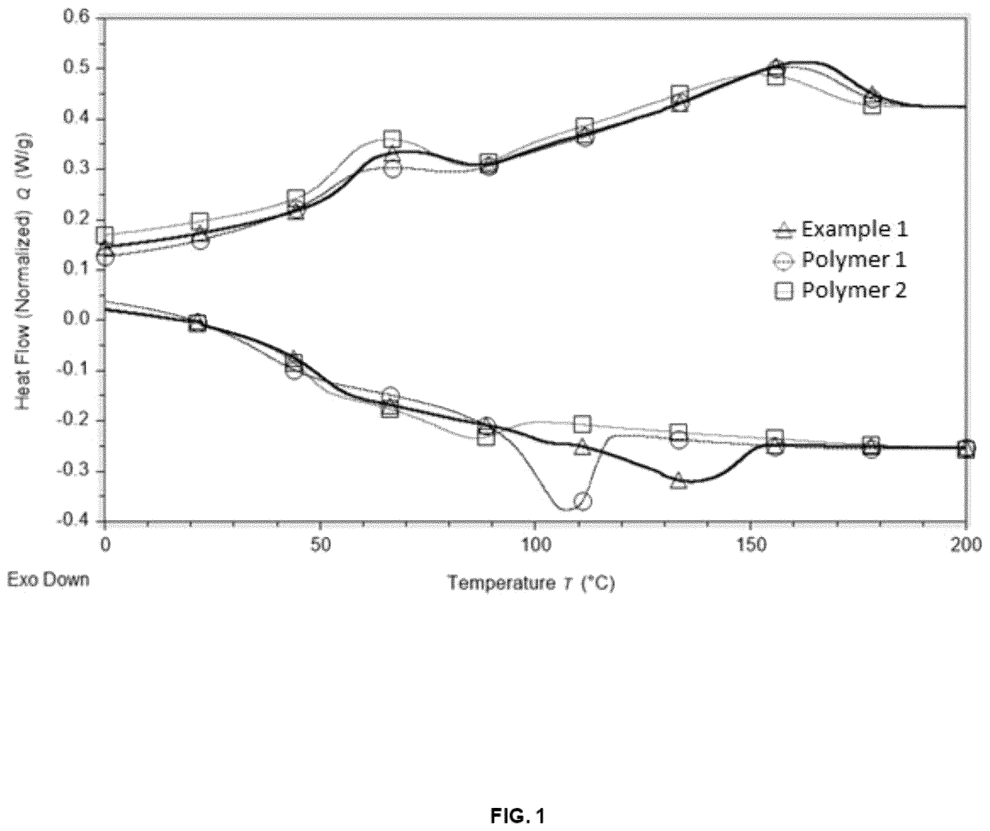

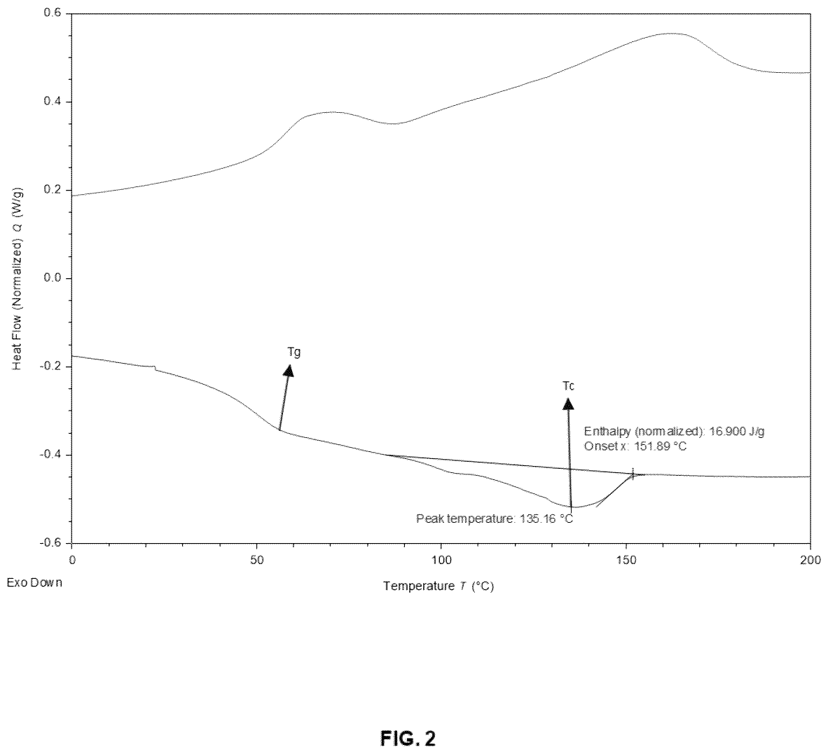

FIG. 1 represents a graph providing an overlay of the respective base resins and Example 1. The heating cycle is the top curve and cooling cycle is the bottom curve. After the Tg in the heating curve, both base resins and Example 1 material display rearrangement and a softening to the Tₘ. Thus, these polymers cannot be fully amorphous and need melt strength to survive the stretching. Also note that the Tₘ is close to the stretching temp of 150° C. As for the Example 1 material, it has a higher crystallization transition (starting around 155° C.) but is much shallower compared to Polymer 1. This is an important factor in the ability of Example 1 to survive stretching and crystallization. Example 1 also has a long crystallization temperature change (85-155° C.), which allows for more time for the polymer to recrystallize during the cooling process. Thus, Example 1 was characterized by a long and shallow crystallization temperature change with much earlier onset of crystallization compared to the base resins (approximately 85-155° C., ΔTc=70° C.). FIG. 2 provides the DSC curves for Example 1 alone.

### Example 3—Application and Stretching of Coating Material

A polypropylene (PP) starting material is provided and melted, and a cast sheet (primary sheet) is produced from the melt by extruding and cooling the melt. Subsequently, the cast sheet is brought to a stretching temperature by reheating, and stretched in the machine direction (MD).

Subsequently, an oxygen barrier coating material produced in accordance with Example 1 is applied to the stretched PP sheet as a coating material, using a reverse gravure coater. For this purpose, engraved rolls are used, which have depressions that are filled with the dispersion on each rotation. In this context, the temperatures of the PP sheet and coating material are lower than 100° C. During contact with the sheet web, part of the liquid is transferred to the sheet. An opposed rotation of the roll counter to the movement direction of the sheet results in a uniform wetting region on the sheet web. In this context, a 12 g/m² gravure roll is used, which produces a wet layer having 12 g aqueous dispersion per square meter sheet surface.

The sheet is then stretched in the transverse direction, with a stretching ratio of 10, in a stretching oven, the preheating zone having a temperature in the range of 175 to 190° C. and the oxygen barrier coating material thus being dried during the preheating in the stretching oven before the stretching to form an oxygen barrier coating layer. The stretching zones have temperatures of 160 to 170° C., and the annealing zone has a temperature in the range of 160 to 168° C. All temperatures set out herein are the temperature of the air in the corresponding zones of the stretching oven.

### Example 4—Oxygen Transmission Measurements

The coated and stretched films were analyzed in duplicate for oxygen transmission rate (OTR) with an Ox-Tran 2/22 OTR Analyzer (Ametek-Mocon, Brooklyn Park, MN). Print samples were mounted to the sample cells such that the biaxially oriented polypropylene film was oriented towards the test gas (100% oxygen). Full test parameters are specified in Table 2, below:

TABLE 2
Ox-Tran 2/22 Experimental Parameters

| Sample Cell Area | 5.62 | cm² |
|---|---|---|
| Carrier Gas | 2% Hydrogen in Nitrogen | |
| Carrier Gas Relative Humidity | 0% | |
| Test Gas | 100% Oxygen | |
| Test Gas Relative Humidity | 0% | |
| Cell Temperature | 23° | C. |
| Test Mode | Convergence by cycle, 3 cycles, | |
| | 1% convergence | |
| Cycle Time | 30 | minutes |

The average OTR with respect to the PP films that were coated with the oxygen barrier coating of Example 1 was 3.8 cc/m²·day at 0% relative humidity.

### Example 5—Laminated Structures

The final coated and stretched films had a coat weight of 1 gsm. These films were laminated with a 2K polyurethane laminating adhesive for packaging (Henkel LOCTITE Liofol 1139-04/6029, Henkel Corp., Rocky Hill, CT) with a coat weight of about 0.6 gsm. Two different backing substrates were used: 2 mil cast polypropylene (CPP) and polyethylene (PE). These laminated structures were tested in duplicate for OTR, using the same instrument for OTR specified above, although humidity was added for certain tests. Results of the oxygen transmission measurements are provided below in Table 3 (CPP substrate) and Table 4 (PE substrate). The bond strength for both laminates were measured with Instron Model 3365, ASTM D903 (1-inch sample strip was pulled at 12 in/min) and the results (average of three sample measurements) are provided below in Table 5.

TABLE 3

| | Carrier | Test RH | AVG OTR |
|---|---|---|---|
| Laminate | RH (%) | (%) | (cc/m² day) |
| BOPP-O2 Barrier Coating | 0 | 0 | 3.8 |
| BOPP-O2 Barrier Coating - | 0 | 0 | 0.95 |
| Laminating Adh - CPP | | | |
| BOPP-O2 Barrier Coating - | 50 | 50 | 1.5 |
| Laminating Adh - CPP | | | |
| BOPP-O2 Barrier Coating - | 75 | 50 | 7.4 |
| Laminating Adh - CPP | | | |
| BOPP-O2 Barrier Coating - | 90 | 0 | 37 |
| Laminating Adh - CPP | | | |

TABLE 4

| | Carrier | Test RH | AVG OTR |
|---|---|---|---|
| Laminate | RH (%) | (%) | (cc/m² day) |
| BOPP-O2 Barrier Coating | 0 | 0 | 3.8 |
| BOPP-O2 Barrier Coating - | 0 | 0 | 0.86 |
| Laminating Adh -PE | | | |
| BOPP-O2 Barrier Coating - | 50 | 50 | 1.7 |
| Laminating Adh -PE | | | |
| BOPP-O2 Barrier Coating - | 75 | 50 | 9.4 |
| Laminating Adh -PE | | | |
| BOPP-O2 Barrier Coating - | 90 | 0 | 40 |
| Laminating Adh -PE | | | |

TABLE 5

| | | Peak | Failure |
|---|---|---|---|
| | | Strength | Mode |
| Laminate | Condition | (gli) | (visual) |
| BOPP-O2 Barrier Coating - | RT | 636 | Stock Tear |
| Laminating Adh - CPP | | | |
| BOPP-O2 Barrier Coating - | RT | 885 | Stock Tear |
| Laminating Adh -PE | | | |

The coated laminate samples in Tables 3 and 4 remained clear, without any visible change from uncoated to coated with the Oxygen Barrier Coating Material of Example 1, to the naked eyes. The results reported in Table 5 indicated that the coating material was effective for maintaining beneficial bond strength characteristics.

### Example 6—Coated Laminated Structures

The barrier coating may be formed on metalized surfaces to further decrease oxygen transmission rate under humidity. Laminate structure having the following layers was formed: BOPP-O2 Barrier Coating-AlOx-Laminating Adhesive-PE. Similarly, laminate structure with aluminum was formed with the following layers: BOPP, creating BOPP-O2 Barrier Coating-Al-Laminating Adhesive-PE. The aluminum or AlOx layer is typically applied by means of vapor deposition, whereby a thin layer of aluminum or a reaction product of aluminum and oxygen is deposited on the surface of the Barrier Coating. Each film type was laminated to 2 mil PE sealant film using recyclable laminating adhesive Loctite Liofol LA 4220 RE with LA 3180 RE curative in a 1:1 mix ratio. The adhesive was applied by hand drawdown and measured 1.08 lb./ream. The OTR of these laminates should be even lower with the addition of the metalized layers in the laminates. Bond strengths of both laminates were measured at 23° C. in accordance with ASTM D903, Instron Tensile machine at 90° angle, and reported in Table 6.

TABLE 6

| | Ave Bond | | |
|---|---|---|---|
| | Strength | Peak Strength | Observed |
| | (gram/linear | (gram/linear | mode of |
| Laminate | inch) | inch) | failure |
| BOPP-O2 Barrier Coating- | 403 | 973 | Stock split |
| AlOx-Laminating Adhesive- | | | |
| PE | | | |
| BOPP-O2 Barrier Coating-Al- | 588 | 629 | Peel with |
| Laminating Adhesive-PE | | | metal split |

Both of the above laminates had bond strength values greater than about 200 grams/linear inch (gli), which is deemed to be acceptable in the art. Both failure modes indicate that the oxygen barrier coating remains adhered onto the metals/metal oxides and PE films.

What is claimed:

1. A material for forming an oxygen barrier coating for a flexible film comprising a polymer or a mixture of polymers having a crystallization temperature change (ΔTc) of at least 40° C. as measured according to D3418-12, a Brookfield viscosity of about 1-75 cP at 25° C., spindle #2 at 100 RPM, wherein the material, when coated onto a stretchable polymeric flexible film having an unstretched area, can be uniaxially or biaxially stretched with the stretchable polymeric flexible film to an stretched area that is at least two times the initial unstretched area.

2. The material according to claim 1, comprising a mixture of (i) a first butenediol vinyl alcohol copolymer and (ii) a second butenediol vinyl alcohol copolymer.

3. The material according to claim 2, wherein the first butenediol vinyl alcohol copolymer has a viscosity of about 2-5 mPa·s when measured in a 4% aqueous solution at 20° C.

4. The material according to claim 2, wherein the second butenediol vinyl alcohol copolymer has a viscosity of about 2.5-5.5 mPa·s when measured in a 4% aqueous solution at 20° C.

5. The material according to claim 2, wherein the second butenediol vinyl alcohol copolymer has a viscosity of when measured in a 4% aqueous solution at 20° C. that is higher than a viscosity of the first butenediol vinyl alcohol copolymer when measured in a 4% aqueous solution at 20° C.

6. The material according to claim 2, wherein the first butenediol vinyl alcohol copolymer has a melting point of about 170-174° C. as measured by DSC according to ASTM D3418-12, and the second butenediol vinyl alcohol copolymer has a melting point of about 157-161° C. as measured by DSC according to ASTM D3418-12.

7. The material according to claim 2, wherein the first butenediol vinyl alcohol copolymer and the second butenediol vinyl alcohol copolymer are present in the coating in a ratio of about 2.3-4:1.

8. The material according to claim 1 having a solids content of about 10-20%.

9. The material according to claim 1 having a ΔTc of at least 50° C.

10. A coated film comprising:
a polymeric flexible film material having a first face and an opposed second face, and
a material according to claim 1 coated onto the first face of the polymeric flexible film.

11. The coated film according to claim 10, wherein the polymeric flexible film material comprises polyamide (PA), polylactic acid (PLAs), polyphenylsulfone (PPSU), polyphenylene sulfide (PPS), polyvinyl chloride (PVC), polyimide kapton (PI), polyethylene terephthalate (PET), polypropylene (PP), polyethylene (PE), polyhydroxyalkanoates (PHA) such as polyhydroxybutyrate (PHB), polyhydroxyhexanoate (PHH), polyhydroxyvalorate (PHV), polyhydroxybutyrate-co-valerate (PHBV), or any combination thereof.

12. The coated film according to claim 10, wherein polymeric flexible film material is suitable for biaxial stretching.

13. The coated film according to claim 10, wherein the coated film when dried and stretched has an oxygen transmission rate of about less than 20 cc/m² per day at 0% relative humidity.

14. A packaging material comprising a coated film according to claim 10.

15. The packaging material according to claim 14, wherein the coated film has been uniaxially or biaxially stretched.

16. The packaging material according to claim 14, further comprising a second flexible film layer that is positioned on at least a portion of the first face of the coated film.

17. An article comprising a packaging material according to claim 14.

18. A method for forming a packaging material with oxygen barrier properties comprising applying a material according to claim 1 onto at least a portion of a first face of a polymeric flexible film.

19. A method for forming a packaging article comprising shaping a coated film according to claim 10 into a container.
